(19) United States
(12) Patent Application Publication
(10) Pub. No.: US 2024/0060719 A1
(43) Pub. Date: Feb. 22, 2024

(54) DEVICE FOR THE DEWATERING AND VOLUME REDUCTION OF MATERIAL TO BE PRESSED, AND METHOD FOR OPERATING SUCH A DEVICE

(71) Applicant: HUBER SE, Berching (DE)

(72) Inventor: Herbert Gilch, Freystadt (DE)

(21) Appl. No.: 18/450,462

(22) Filed: Aug. 16, 2023

(30) Foreign Application Priority Data
Aug. 18, 2022 (DE) 10 2022 120 864.8

(51) Int. Cl. F26B 5/14; B30B 9/12

(52) U.S. Cl. CPC F26B 5/14; B30B 9/12

(57) ABSTRACT

A method for operating a device for the dewatering and volume reduction of material to be pressed, more particularly sludge, removed solids or screenings, controls the rotational speed of a screw shaft that expels liquid out of the material to be pressed in a pressing arrangement. The control is based either on detecting a torque applied by a drive motor to the screw shaft or detecting an internal pressure prevailing within the pressing arrangement. According to the invention, a torque characteristic curve can be changed on the basis of the detected internal pressure and/or a pressure characteristic curve can be changed on the basis of the detected torque. Moreover, the invention relates to a device for the dewatering and volume reduction of material to be pressed.

### FIELD OF THE INVENTION

The present invention relates to a method for operating a device for the dewatering and volume reduction of material to be pressed, more particularly sludge, removed solids or screenings, the method including the following steps: introducing the material to be pressed into a pressing arrangement, driving a screw shaft of the pressing arrangement at a rotational speed by means of a drive motor, expelling an existing liquid out of the material to be pressed by means of the screw shaft, detecting a torque applied by the drive motor and an internal pressure prevailing within the pressing arrangement, and controlling the rotational speed of the screw shaft on the basis of the torque along a torque characteristic curve and/or on the basis of the internal pressure along a pressure characteristic curve. Moreover, the invention relates to a device for the dewatering and volume reduction of material to be pressed.

### BACKGROUND OF THE INVENTION

DE 199 02 480 A1, which corresponds to U.S. Pat. No. 6,217,710 that is hereby incorporated herein in its entirety for all purposes, describes a method for controlling a screw press, in which the rotational speed is varied as a function of the torque. Such control systems, which can also be referred to as torque controllers, have the disadvantage that these control systems can respond in a very sluggish manner and/or too slowly. As a result, the response to pressure jumps, such as those that can arise in the start-up phase or when there are changes in the sludge, is too slow.

Pressure controllers that can vary the rotational speed as a function of the internal pressure are also known from the prior art. Such pressure controllers have the disadvantage, however, that these can respond too quickly. As a result, the response to pressure jumps can cause the control to oscillate. In the absence of suitable damping, this oscillation would result in an unstable vibration behavior and possibly in damage to the screw press.

### OBJECTS AND BRIEF SUMMARY OF THE INVENTION

The problem addressed by the present invention is that of eliminating the disadvantages known from the prior art.

The problem is solved by a method for operating a device for the dewatering and volume reduction of material to be pressed and to an appropriate device having the features described herein.

The invention relates to a method for operating a device for the dewatering and volume reduction of material to be pressed, more particularly of sludge, removed solids or screenings. The method includes at least the steps described in the following:

The material to be pressed is introduced into a pressing arrangement of the device for dewatering and volume reduction. A screw shaft of the pressing arrangement is driven by means of a drive motor, and so the screw shaft rotates at a rotational speed. An existing liquid is expelled out of the material to be pressed by means of the screw shaft. A torque applied by the drive motor and an internal pressure prevailing within the pressing arrangement are detected. The rotational speed of the screw shaft is controlled on the basis of the torque along a torque characteristic curve and/or on the basis of the internal pressure along a pressure characteristic curve.

The applied torque is preferably the torque of the drive motor (which is preferably in the form of an electric motor), wherein the torque is determined and monitored, for example, by means of a torque sensor or, for example, indirectly by measuring the (electrical) power of the drive motor at its inverter. Alternatively, the output-side torque of a gear mechanism arranged between the screw shaft and the drive motor could also be taken into account, wherein it is preferred when the torque of the drive motor is taken into account.

The device for the dewatering and volume reduction of material to be pressed can be, for example, a screw press or a wash press. Screw presses or wash presses are used, for example, in sewage treatment plants. The material to be pressed can be, for example, sludge, removed solids or screenings. Sludge is understood to be a suspension made up of an aqueous liquid and solids contained therein. Removed solids or screenings are understood to be the solids, for example, from a sewage treatment system or a sewer, which have been separated out by means of a screen. The material to be pressed, both in the form of sludge and in the form of removed solids or screenings, has a high water content which is reduced by means of the device.

A screw shaft is understood to be a shaft which has an interior axis and at least one helix extending about this axis (comparable to an Archimedean screw). More particularly when the device is in the form of a screw press, the spacing between adjacent helix portions can decrease, at least in sections, in the direction of conveyance of the material to be pressed toward an outlet opening and/or a discharge opening, as a result of which the material to be pressed, more particularly the sludge, is compressed. If the screw shaft rotates about an axis of rotation, the material to be pressed is conveyed in the direction of conveyance and the included liquid, more particularly the water, is expelled out of the material to be pressed.

The device preferably has an inlet opening for introducing the material to be pressed into the pressing arrangement. An inlet opening is understood to be an opening, through which the material to be pressed can be transported to the pressing arrangement. The material to be pressed, more particularly in the form of sludge, can be transported to the device through a sludge supply line.

The pressing arrangement has, in addition to the screw shaft, a surrounding screen basket. The screen basket preferably has at least one liquid-permeable screen portion and at least one liquid-impermeable compacting portion. The screen basket surrounds the screw shaft such that the material to be pressed, during transport in the conveying direction, is pressed laterally by the rotating screw shaft against the at least one screen portion and at least one compacting portion and, thus, is dewatered, wherein the liquid can pass through the at least one screen portion, while the large part of the solids is retained.

The device preferably has the outlet opening for discharging the expelled liquid, the outlet opening being arranged at the screen basket, more particularly in the region of the screen portion. The liquid that has been expelled out of the material to be pressed by means of the screw shaft is screened through the screen portion and, thereafter, reaches the outlet opening. Additionally, a filtrate basin can be arranged underneath the screw shaft. The filtrate basin can collect the expelled liquid (=filtrate) during the operation of the device and/or the liquid can be transported in the filtrate basin toward the outlet opening.

Finally, the device preferably has the at least one discharge opening for the material to be pressed, which has been at least partially dewatered by means of the pressing arrangement. A pressing element should be present in the region of the discharge opening. Preferably, the pressing element is displaceable, so that the passage opening of the discharge opening can be changed by means of the pressing element in order to thereby be able to adjust the counter-pressure during the compacting operation. Together with the introduced quantity of material to be pressed and/or the speed at which the material to be pressed is introduced, the counter-pressure determines the internal pressure in the pressing arrangement. The torque is also preferably dependent on these factors.

As described above, the torque applied by the drive motor and the internal pressure prevailing within the pressing arrangement are detected. The rotational speed of the screw shaft can be controlled as a function of the torque on the basis of the torque characteristic curve, which establishes the connection or relationship between the rotational speed and the torque. This can also be referred to as torque control. Additionally or alternatively, the rotational speed of the screw shaft can be controlled as a function of the internal pressure on the basis of the pressure characteristic curve, which establishes the connection or relationship between the rotational speed and the internal pressure. This can also be referred to as pressure control.

In the method according to the invention, the torque characteristic curve is changed on the basis of the internal pressure and/or the pressure characteristic curve is changed on the basis of the torque. As a result, the control of the rotational speed of the screw shaft can depend on the torque as well as on the internal pressure, which results in a fast and nevertheless stable control. Pressure changes can therefore act on the torque controller. Additionally or alternatively, torque changes can act on the pressure controller.

If the torque characteristic curve is changed on the basis of the internal pressure, the sluggish behavior of the torque controller can be accelerated. The torque controller is manipulated by the internal pressure and the pressure controller. If the pressure characteristic curve is changed on the basis of the torque, the unstable vibration behavior can be stabilized. The pressure controller is manipulated by the torque and the torque controller. Preferably, the pressure controller is operated simultaneously with the torque controller, wherein only one of the controllers, as the pressure controller or the torque controller, actively controls the rotational speed of the screw shaft. The other controller, which is not actively acting, changes the characteristic curve of the actively acting controller when the internal pressure and/or the torque changes.

It is advantageous when the torque characteristic curve is changed when the internal pressure abruptly changes and/or the pressure characteristic curve is changed when the torque abruptly changes. More particularly during the abrupt change of the internal pressure and/or of the torque, the torque controller responds too sluggishly and/or the pressure controller responds too quickly. The change in the torque characteristic curve and/or the pressure characteristic curve during such abrupt changes therefore has a particularly advantageous effect on the response of the torque controller and/or of the pressure controller. Such abrupt changes are to be observed primarily during the start-up of the screw shaft and/or when there are changes in the composition of the material to be pressed.

It is also advantageous when a first rotational speed is associated with a first internal pressure and a second rotational speed is associated with a second internal pressure with respect to the pressure characteristic curve and/or a lower rotational speed is associated with a first torque and an upper rotational speed is associated with a second torque with respect to the torque characteristic curve. The pressure characteristic curve of the pressure controller therefore extends from the first rotational speed to the second rotational speed when the internal pressure changes from the first internal pressure to the second internal pressure. As a result, the pressure characteristic curve can be defined by means of at least these rotational speeds and internal pressures. For example, the first internal pressure, the second internal pressure, the first rotational speed and the second rotational speed define the control range of the pressure controller. Within this control range, the rotational speed of the screw shaft is controlled and/or set according to the internal pressure.

The torque characteristic curve of the torque controller extends from the lower rotational speed to the upper rotational speed when the torque changes from the first torque to the second torque. As a result, the torque characteristic curve can be defined by means of at least these rotational speeds and torques. For example, the first torque, the second torque, the lower rotational speed, and the upper rotational speed define the control range of the torque controller. Within this control range, the rotational speed of the screw shaft is controlled and/or set according to the torque.

More particularly, it is advantageous when the lower rotational speed is changed depending on the internal pressure. In this case, the lower rotational speed tracks the internal pressure, preferably linearly. Therefore, when the internal pressure increases, the rotational speed that the drive has at a certain torque also increases. Likewise the rotational speed drops at a certain torque when the internal pressure drops. The lower rotational speed, which, together with the upper rotational speed, defines the torque characteristic curve, is therefore changed as a function of the internal pressure, preferably in a speed range that has been delimited in a defined manner, and so the torque characteristic curve also changes in this range as a function of the internal pressure.

Alternatively, it is also conceivable, of course, to change the upper rotational speed as a function of the internal pressure. In this case, the upper rotational speed tracks the internal pressure, preferably linearly. Therefore, when the internal pressure increases in a defined rotational speed range, the upper rotational speed that the drive is to have at a certain torque would also be adapted in this case. Likewise the upper rotational speed drops at a certain torque when the internal pressure drops. The upper rotational speed is therefore changed as a function of the internal pressure, preferably in a speed range that has been delimited in a defined manner, and so the torque characteristic curve also changes in this range as a function of the internal pressure.

Finally, it is also possible for the lower rotational speed as well as the upper rotational speed to track the internal pressure, wherein this tracking preferably always takes place only in a rotational speed range that has been defined in the controller, as in the two aforementioned cases as well. It is therefore conceivable that the torque characteristic curve does not depend on the internal pressure in a certain rotational speed range and therefore corresponds to the original torque curve.

It is also advantageous when the torque characteristic curve and/or the pressure characteristic curve extend(s) linearly. This has the advantage that the pressure characteristic curve can be defined by means of the first internal pressure, the second internal pressure, the first rotational speed and the second rotational speed, since the pressure characteristic curve can be linearly interpolated between these internal pressures and rotational speeds and also beyond. Additionally or alternatively, the torque characteristic curve can be defined by means of the first torque, the second torque, the lower rotational speed and the upper rotational speed. In this case as well, the torque characteristic curve can be linearly interpolated between these torques and rotational speeds and also beyond.

It is also advantageous when the rotational speed is increased when the torque is increasing and/or the internal pressure is increasing. Due to the increasing rotational speed, the conveyance speed can be increased, as a result of which, when the torque is increasing and/or the internal pressure is increasing, the dewatered and compacted material has properties that are as constant as possible when the material emerges from the discharge opening.

It is also advantageous when the first rotational speed, the second rotational speed and/or the upper rotational speed are/is specified, more particularly manually. In this way, the first rotational speed, the second rotational speed and/or the upper rotational speed are/is fixed at least for as long as it takes until these/this are/is switched, more particularly manually. Due to the specification of the rotational speeds, the torque characteristic curve and/or the pressure characteristic curve are/is at least partially defined. In addition, due to the manual specification, the method can be manually switched in the event of longer-term changes.

Advantageously, the first rotational speed is lower than the second rotational speed and/or the second rotational speed is lower than the upper rotational speed. As a result, the pressure characteristic curve can be at least partially defined. In addition, as a result, the control range of the torque characteristic curve can extend in a higher rotational speed range than the control range of the pressure characteristic curve. Therefore, the rotational speed depends on the internal pressure, more particularly upon the start of the device and in the start-up phase. In this way, a faster start-up of the device can be ensured.

It is also advantageous when the lower rotational speed of the torque characteristic curve, more particularly when the first torque is constant, is changed as a function of the internal pressure prevailing in the pressing arrangement. The slope of the torque characteristic curve can be changed by means of the change in the lower rotational speed. This yields a simple possibility for controlling and/or changing the torque characteristic curve on the basis of the internal pressure.

It is also advantageous when the lower rotational speed of the torque characteristic curve assumes a variable rotational speed between the first rotational speed and the second rotational speed on the basis of the internal pressure prevailing in the pressing arrangement. The pressure characteristic curve therefore results in the value of the lower rotational speed and, therefore, of the slope of the torque characteristic curve. As a result, the pressure controller intervenes in the operation of the device merely indirectly by means of the torque controller. This has the advantage that exclusively the torque controller directly controls the rotational speed of the screw shaft. The indirect control of the pressure controller is therefore at least partially damped by the torque controller.

It is advantageous when an initial rotational speed is specified for the lower rotational speed of the torque characteristic curve. In this way, the control can be carried out already on the basis of the torque upon start-up of the device, even though the variable rotational speed depends on the rotational speed specification of the pressure controller. Therefore, there is no need to wait for a rotational speed specification from the pressure controller. Preferably, the initial rotational speed is equal to the first rotational speed. This ensures a start-up of the device that is as gentle as possible. It is therefore advantageous when the initial rotational speed has a certain absolute value, which is stored in the controller, wherein the drive is operated at this initial rotational speed and under consideration of the torque characteristic curve upon start-up of the device until the internal pressure reaches or exceeds a defined minimum absolute value. From this point forward, the rotational speed is finally controlled and the torque characteristic curve is finally adapted under consideration of the internal pressure.

It is also advantageous when a minimum and/or maximum internal pressure and/or a minimum and/or maximum torque are/is defined in the controller. If the minimum torque is fallen below, the rotational speed remains constant at the aforementioned lower rotational speed. If the maximum torque is exceeded, the rotational speed remains constant at the aforementioned upper rotational speed. If the minimum internal pressure is fallen below, the rotational speed remains constant at the aforementioned first rotational speed. If the maximum internal pressure is exceeded, the rotational speed remains constant at the aforementioned second rotational speed.

It is also advantageous when the first internal pressure, the second internal pressure, the first torque and/or the second torque are/is specified, more particularly manually. As a result, the pressure characteristic curve and/or the torque characteristic curve are/is at least partially defined. In addition, due to the manual specification, the method can be manually switched in the event of longer-term changes. Advantageously, the first internal pressure is less than the second internal pressure and/or the first torque is less than the second torque.

Moreover, it is advantageous when at least one of the following rotational speeds, torques and/or internal pressures is specified:
first rotational speed of 0.01 1/min to 10.00 1/min, preferably of 0.05 1/min to 2.00 1/min;
second rotational speed of 0.1 1/min to 20.0 1/min, preferably of 0.2 1/min to 5.0 1/min;
initial rotational speed of the lower rotational speed of 0.01 1/min to 10.00 1/min, preferably of 0.05 1/min to 2.00 1/min;
upper rotational speed of 0.1 1/min to 20.0 1/min, preferably of 0.2 1/min to 5.0 1/min;
first torque of 0 Nm to 15 Nm, preferably of 0 Nm to 10 Nm;
second torque of 1 Nm to 30 Nm, preferably of 1 Nm to 20 Nm;
first internal pressure of 1 mbar to 500 mbar, preferably of 1 mbar to 300 mbar, and/or
second internal pressure of 1 mbar to 1500 mbar, preferably of 1 mbar to 600 mbar.

Particularly stable operation of the device is possible with the aforementioned values.

It is also advantageous when a torque damping damps the rotational speed change when the rotational speed of the screw shaft is controlled on the basis of the torque and/or an internal pressure damping damps the rotational speed change when the rotational speed of the screw shaft is controlled on the basis of the internal pressure. As a result, the control can be additionally damped. Moreover, the control can be changed by specifying the torque damping and/or the internal pressure damping. Such a damping can bring about, for example, a temporal offset of the control. As a result, the method can be stabilized as necessary.

Moreover, a device is provided for the dewatering and volume reduction of material to be pressed, more particularly sludge, removed solids or screenings. The device has a pressing arrangement, by means of which the material to be pressed is subjected to a compacting operation during operation of the device. In the compacting operation, an internal pressure is generated within the pressing arrangement by means of a rotating screw shaft and, in this way, liquid present in the material to be pressed is expelled out of the material to be pressed. In addition, the device has a drive motor, by means of which torque is transmitted onto the screw shaft. Moreover, the device has a control unit, which controls a torque controller for controlling the rotational speed of the screw shaft on the basis of the torque along a torque characteristic curve and/or a pressure controller for controlling the rotational speed of the screw shaft on the basis of the internal pressure along a pressure characteristic curve.

According to the invention, the control unit is designed to change the torque characteristic curve on the basis of the internal pressure and/or the pressure characteristic curve on the basis of the torque. Due to the control unit according to the invention, the control of the rotational speed of the screw shaft can depend on the torque as well as on the internal pressure, which results in a fast and nevertheless stable control. Pressure changes can therefore act on the torque controller. Additionally or alternatively, torque changes can act on the pressure controller.

It is advantageous when the device is designed according to the preceding and/or following description, wherein the aforementioned features can be present individually or in any combination.

It is also advantageous when the device and/or the control unit have/has at least one setting unit (for example, a HMI) for specifying a first rotational speed, a second rotational speed, a lower rotational speed, an upper rotational speed, a first internal pressure, a second internal pressure, a first torque and/or a second torque. With the setting unit, a simple device can be created, by means of which the individual control parameters of the control unit can be specified and/or manually input.

Moreover, it is advantageous when the device includes at least one measuring device for measuring the rotational speed, the torque and/or the internal pressure. To this end, it is advantageous when the measuring device has at least one rotational speed sensor, one torque sensor and/or one pressure sensor. The measuring device can therefore deliver all necessary measurement variables for controlling the device.

### BRIEF DESCRIPTION OF THE DRAWING

Further advantages of the invention are described in the following exemplary embodiment, wherein:

FIG. 1 shows a schematic partial cutaway side view of a device for the dewatering and volume reduction of material to be pressed and selected diagrams to clarify the invention.

### DETAILED DESCRIPTION OF EXEMPLARY EMBODIMENTS OF THE INVENTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action without necessarily requiring or implying any actual relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The singular forms “a,” “an,” and “the” include plural references unless the context clearly dictates otherwise.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features unless otherwise specified herein. The terms “upstream” and “downstream” refer to the relative direction with respect to a flow or movement direction of a material and/or a fluid. For example, “upstream” refers to the direction from which a material and/or a fluid flows, and “downstream” refers to the direction to which the material and/or the fluid moves. The term “selectively” refers to a component's ability to operate in various states (e.g., an ON state and an OFF state) based on manual and/or automatic control of the component. The term “radial” defines a direction that is perpendicular to an axis of rotation and the term “axial” defines a direction that is parallel to the axis of rotation.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

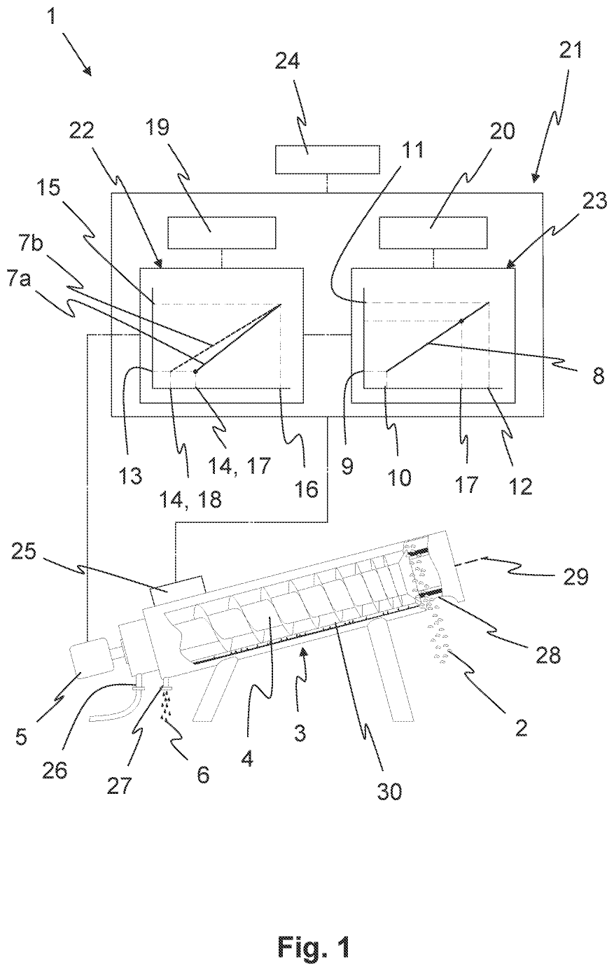

The sole FIG. 1 shows a schematic partial cutaway side view of a device for the dewatering and volume reduction of material to be pressed. A screw press is shown as the device 1 for the dewatering and volume reduction of material to be pressed 2. The device 1 is supported via an appropriate supporting structure (which can also include, in addition to the support legs shown, various longitudinal members and/or crossmembers or also any type of frame elements). The device 1 has an inlet opening 26 for introducing the material to be pressed 2. The inlet opening 26 can be connected, for example, to a sludge supply line, via which, for example, the sludge, as the material to be pressed 2, can be introduced.

A pressing arrangement 3 extends downstream of the inlet opening 26 and has a screw shaft 4, which can be set into rotation about a rotational axis 29 by a drive motor 5. The screw shaft 4 preferably has an axis, around which one helix or multiple helixes are arranged. The screw shaft 4 is surrounded by a screen basket 30. The screen basket 30 has at least one liquid-permeable screen portion (not shown), through which a liquid 6 of the material to be pressed 2 can escape. For example, the liquid 6 is subsequently collected by means of at least one filtrate basin.

As the material to be pressed 2 is conveyed along the conveying direction, the material to be pressed 2 is dewatered due to the pressing action between the screw shaft 4 and the screen basket 30. Due to the changing, preferably decreasing, pitch of the helix and/or its outer diameter of the axis, which is possibly changing, preferably increasing, in the direction of a discharge opening, the material to be pressed 2 is finally compacted and pressed from the inside against the screen basket 30, as a result of which the liquid 6 exits through openings (holes or slots) in the screen basket 30. As a result, the liquid 6 present in the material to be pressed 2 is expelled.

In order to support the compacting operation, the pressing arrangement 3 preferably has a mating surface, for example, in the form of the pressure cone shown. The pressure cone is located in the upper end region of the screw shaft 4 and forms, with a corresponding outer wall or the screen basket 30, an annular gap, through which the dewatered material to be pressed 2, more particularly sludge, can pass. Due to the displacement of the pressure cone in the axial direction of the screw shaft 4, the aforementioned gap can finally be changed and, thereby, the counter-pressure can be adapted during the compacting operation (for example, one or multiple, for example, pneumatically actuatable, displacement element(s) is/are present for this purpose). This can result in a change in the internal pressure within the pressing arrangement 3.

As described above, the liquid 6 is finally collected by the at least one filtrate basin arranged underneath the screw shaft 4 and guided in the direction of an outlet opening 27. There, the liquid 6 can be removed by means of a hose arrangement (not shown) or collected by means of a collecting device. In turn, the material to be pressed 2, which is to be dewatered and compacted, is conveyed by means of the screw shaft 4 from the inlet opening 26 in the direction of the discharge opening 28 and, thereby, dewatered, until the material to be pressed 2 reaches the discharge opening 28 as dewatered material to be pressed 2. For the sake of clarity, the material to be pressed 2, which is to be dewatered and compacted and is located between the screw shaft 4 and the screen basket 30, is not shown. Only the dewatered material to be pressed 2 emerging from the discharge opening 28 is shown.

During operation of the device 1, the screw shaft 4 is driven at a rotational speed by means of the drive motor 5. To this end, the drive motor 5 introduces a torque. The torque and the rotational speed can be detected, for example, via the drive motor 5 and/or via a measuring device 25. In addition, the measuring device 25 can be designed to detect the internal pressure prevailing in the pressing arrangement 3. To this end, the measuring device 25 can include a rotational speed sensor, a torque sensor and/or a pressure sensor. For the sake of clarity, the individual sensors are not shown, although it is conceivable that the rotational speed sensor and/or the torque sensor are/is arranged at the drive motor 5 and/or between the drive motor 5 and the screw shaft 4. The pressure sensor can preferably be arranged within the screen basket 30.

The rotational speed of the screw shaft 4 is controlled on the basis of a torque characteristic curve 7a, 7b and/or on the basis of a pressure characteristic curve 8. The rotational speed of the screw shaft 4 is therefore controlled such that, in the case of control on the basis of the torque characteristic curve 7a, 7b, the rotational speed assumes an assigned rotational speed at a certain torque. In the case of the pressure characteristic curve 8, the rotational speed of the screw shaft 4 assumes an assigned rotational speed at a certain internal pressure. To this end, the device 1 according to the invention has a control unit 21 in the exemplary embodiment shown. The control unit 21 has a torque controller 22 for controlling the rotational speed of the screw shaft 4 on the basis of the torque along the torque characteristic curve 7a, 7b and/or a pressure controller 23 for controlling the rotational speed of the screw shaft 4 on the basis of the internal pressure along the pressure characteristic curve 8.

In order to achieve a more stable behavior, the torque characteristic curve 7a, 7b is changed on the basis of the internal pressure and/or the pressure characteristic curve 8 is changed on the basis of the torque. To this end, for example, the pressure controller 23 can act on the torque controller 22 such that the torque characteristic curve 7a, 7b is changed. This behavior with respect to changes is explained in greater detail in the following. The torque controller 22 directly controls the rotational speed of the screw shaft 4. The pressure controller 23 in this exemplary embodiment is designed only to change the torque characteristic curve 7a, 7b and, therefore, acts on the rotational speed of the screw shaft 4 merely indirectly via the torque controller 22. It is also conceivable that the torque controller 22 acts on the rotational speed indirectly via the pressure controller 23.

The torque characteristic curve 7a, 7b as well as the pressure characteristic curve 8 advantageously extend linearly in the exemplary embodiment shown. With respect to the pressure characteristic curve 8, a first rotational speed 10 is assigned to a first internal pressure 9 and a second rotational speed 12 is assigned to a second internal pressure 11. The region between these assigned values can be referred to as a control range of the pressure controller 23. The behavior with respect to the torque characteristic curve 7a, 7b is similar, in which a lower rotational speed 14 is assigned to a first torque 13 and an upper rotational speed 16 is assigned to a second torque 15. This range can be referred to as a control range of the torque controller 22. As is shown by the torque characteristic curve 7a, 7b and the pressure characteristic curve 8, the rotational speed is increased when the torque is increasing and/or the internal pressure is increasing.

The device 1 has at least one setting unit 24 for, more particularly manually, specifying the first rotational speed 10, the second rotational speed 12, the lower rotational speed 14, the upper rotational speed 16, the first internal pressure 9, the second internal pressure 11, the first torque 13 and/or the second torque 15.

In order to be able to act on the torque controller 22 with the pressure controller 23, for example, the lower rotational speed 14 of the torque controller 22 is in the form of a variable rotational speed 17 in the exemplary embodiment shown. The lower rotational speed 14, as a variable rotational speed 17, is therefore changed as a function of the internal pressure. In this case, an initial rotational speed 18, instead of the lower rotational speed 14, can be specified for the lower rotational speed 14 by means of the setting unit 24. In the course of the operation of the device 1, the initial rotational speed 18 can change into the variable rotational speed 17 as the lower rotational speed 14. For example, the first rotational speed 10 of the pressure controller 23 can be used as the initial rotational speed 18.

In this way, the internal pressure within the pressing arrangement 3 is measured and transmitted to the control unit, for example, by means of the measuring unit 25. On the basis of the internal pressure, the assigned rotational speed for the measured internal pressure is determined by the pressure controller 23. This assigned rotational speed for the measured internal pressure is transmitted to the torque controller 22 and the lower rotational speed 14 is changed on the basis of this rotational speed. In the exemplary embodiment shown, this assigned rotational speed is transmitted as a variable rotational speed 17 to the torque controller 22. Preferably, the lower rotational speed 14 of the torque controller 22 subsequently assumes the variable rotational speed 17. Two torque characteristic curves 7a, 7b are shown in the exemplary embodiment shown in order to illustrate the change from the initial rotational speed 18 to the variable rotational speed 17. The torque characteristic curve 7b is based on the initial rotational speed 18 and is shown as a dashed line. The torque characteristic curve 7a is based on the variable rotational speed 17, which is transmitted from the pressure controller 23 to the torque controller 22. The torque characteristic curve 7a is shown as a solid line.

As is apparent from the pressure characteristic curve 8 and the torque characteristic curve 7a, 7b, the first rotational speed 10 is lower than the second rotational speed 12. The lower rotational speed 14 of the torque characteristic curve 7a, as a variable rotational speed 17, is greater than or equal to the first rotational speed 10 and less than or equal to the second rotational speed 12, since this is dependent on the internal pressure. By contrast, the upper rotational speed 16 is always greater than the first rotational speed 10, the second rotational speed 12 and the lower rotational speed 14. Due to the effect on the slope of the torque characteristic curve 7a, 7b, however, the internal pressure acts on the control over the entire rotational speed range (and not only the limited rotational speed range of the pressure controller). The linear torque characteristic curve 7a, 7b therefore becomes steeper when the internal pressure increases. This corresponds to the change from the torque characteristic curve 7b to the torque characteristic curve 7a. When the internal pressure decreases, the linear torque characteristic curve 7a, 7b becomes flatter. This corresponds to the change from the torque characteristic curve 7a to the torque characteristic curve 7b.

In order to damp the rotational speed change, the torque controller 22 can be damped by means of a torque damping 19 and the pressure controller 23 can be damped by means of an internal pressure damping 20.

The present invention is not limited to the represented and described exemplary embodiments. Modifications within the scope of the claims are also possible, as is any combination of the features, even if they are represented and described in different exemplary embodiments.

### LIST OF REFERENCE CHARACTERS

1 device
2 material to be pressed
3 pressing arrangement
4 screw shaft
5 drive motor
6 liquid
7a, 7b torque characteristic curve
8 pressure characteristic curve
9 first internal pressure
10 first rotational speed
11 second internal pressure
12 second rotational speed
13 first torque
14 lower rotational speed
15 second torque
16 upper rotational speed
17 variable rotational speed
18 initial rotational speed
19 torque damping
20 internal pressure damping
21 control unit
22 torque controller
23 pressure controller
24 setting unit
25 measuring device
26 inlet opening
27 outlet opening
28 discharge opening
29 rotational axis
30 screen basket

What is claimed is:

1. A method for operating a device for the dewatering and volume reduction of material to be pressed, the method including the following steps:
introducing the material to be pressed into a pressing arrangement that includes a screw shaft,
driving a screw shaft of the pressing arrangement at a rotational speed by means of a drive motor,
expelling an existing liquid out of the material to be pressed by means of the screw shaft,
detecting a torque applied by the drive motor,
detecting an internal pressure prevailing within the pressing arrangement, and
controlling the rotational speed of the screw shaft on the basis of the torque along a torque characteristic curve, wherein the torque characteristic curve is changed on the basis of the internal pressure.

2. The method of claim 1, wherein with respect to the torque characteristic curve, a lower rotational speed is assigned to a first torque and an upper rotational speed is assigned to a second torque.

3. The method of claim 1, wherein the torque characteristic curve extend(s) linearly.

4. The method of claim 1, wherein the rotational speed is increased when the torque is increasing.

5. The method of claim 1, wherein the first rotational speed, the second rotational speed and/or the upper rotational speed are/is specified.

6. The method of claim 1, wherein the lower rotational speed of the torque characteristic curve is changed as a function of the internal pressure prevailing in the pressing arrangement.

7. The method of claim 1, wherein the lower rotational speed of the torque characteristic curve assumes a variable rotational speed between the first rotational speed and the second rotational speed on the basis of the internal pressure prevailing in the pressing arrangement.

8. The method of claim 1, wherein an initial rotational speed is specified for the lower rotational speed of the torque characteristic curve.

9. The method of claim 1, wherein the first internal pressure, the second internal pressure, the first torque and/or the second torque are/is specified.

10. The method of claim 1, wherein at least one of the following rotational speeds, torques and/or internal pressures is specified:
first rotational speed of 0.01 1/min to 10.00 1/min;
second rotational speed of 0.1 1/min to 20.0 1/min;
initial rotational speed of the lower rotational speed of 0.01 1/min to 10.00 1/min;
upper rotational speed of 0.1 1/min to 20.0 1/min;
first torque of 0 Nm to 15 Nm;
second torque of 1 Nm to 30 Nm;
first internal pressure of 1 mbar to 500 mbar, and/or
second internal pressure of 1 mbar to 1500 mbar.

11. The method of claim 1, wherein a torque damping damps the rotational speed change when the rotational speed of the screw shaft is controlled on the basis of the torque and/or an internal pressure damping damps the rotational speed change when the rotational speed of the screw shaft is controlled on the basis of the internal pressure.

12. A device for the dewatering and volume reduction of material to be pressed, comprising:
a pressing arrangement configured to perform a compacting operation that compacts the material to be pressed during operation of the device,
a screw shaft rotatably supported within the pressing arrangement;
wherein during the compacting operation, an internal pressure is generated within the pressing arrangement by means of rotation of the screw shaft and, in this way, liquid present in the material to be pressed is expelled out of the material to be pressed,
a drive motor configured and disposed to transmit a torque onto the screw shaft, and
a control unit, which has a torque controller configured for controlling the rotational speed of the screw shaft on the basis of the torque along a torque characteristic curve;
wherein the control unit is designed to change the torque characteristic curve on the basis of the internal pressure.

13. The device of claim 12, wherein the control unit has at least one setting unit for specifying a first rotational speed, a second rotational speed, a lower rotational speed, an upper rotational speed, a first internal pressure, a second internal pressure, a first torque and/or a second torque.

14. The device of claim 12, further comprising at least one measuring device configured for measuring the rotational speed, the torque and/or the internal pressure.

15. The device of claim 12, wherein the control unit includes a pressure controller configured and disposed for controlling the rotational speed of the screw shaft on the basis of the internal pressure along a pressure characteristic curve, wherein the control unit is designed to change the pressure characteristic curve on the basis of the torque.

16. The method of claim 1, comprising further controlling the rotational speed of the screw shaft on the basis of the internal pressure along a pressure characteristic curve, wherein the pressure characteristic curve is changed on the basis of the torque.

17. The method of claim 16, wherein with respect to the pressure characteristic curve, a first rotational speed is assigned to a first internal pressure and a second rotational speed is assigned to a second internal pressure.

18. The method of claim 16, wherein the pressure characteristic curve extends linearly.

19. The method of claim 1, wherein the rotational speed is increased when the internal pressure is increasing.
